(19) United States
(12) Patent Application Publication
(10) Pub. No.: US 2026/0017006 A1
(43) Pub. Date: Jan. 15, 2026

(54) CONTENT SHARING METHOD AND APPARATUS, AND ELECTRONIC DEVICE

(71) Applicant: BEIJING BAIDU NETCOM SCIENCE TECHNOLOGY CO., LTD., Beijing (CN)

(72) Inventors: Sining Zhang, Beijing (CN); Xiaohua Ren, Beijing (CN); Xiaolin Huang, Beijing (CN); Huibin Zhao, Beijing (CN); Tian Wu, Beijing (CN)

(73) Assignee: BEIJING BAIDU NETCOM SCIENCE TECHNOLOGY CO., LTD., Beijing (CN)

(21) Appl. No.: 19/334,180

(22) Filed: Sep. 19, 2025

(30) Foreign Application Priority Data
Jul. 25, 2025 (CN) 202511039067.0

(51) Int. Cl. G06F 3/14; G06F 21/62

(52) U.S. Cl. CPC G06F 3/1454; G06F 21/6254

(57) ABSTRACT

A content sharing method includes: obtaining a first multimedia content to be shared in a terminal during a session between the terminal and a large model; performing a content desensitization processing on a sensitive content in the first multimedia content, and obtaining a second multimedia content by performing a type labeling processing on a position of the sensitive content in the first multimedia content, in which a type labeled by the type label processing is a type of the sensitive content; and sharing with the large model the second multimedia content for the session.

### CROSS REFERENCE TO RELATED APPLICATIONS

This application claims priority and benefits to Chinese Application No. 2025110390670, filed on Jul. 25, 2025, the entire content of which is incorporated herein by reference.

### TECHNICAL FIELD

The disclosure relates to the field of artificial intelligence technology, such as deep learning, natural language processing, computer vision, voice technology and large model, in particular to a content sharing method, a content sharing apparatus and an electronic device.

### BACKGROUND

Currently, in a session between a terminal and a large model, the terminal can share its screen content with the large model during the session.

In existing solutions, the leakage of sensitive content may be caused while sharing the screen content.

### SUMMARY

The disclosure provides a content sharing method, a content sharing apparatus and an electronic device.

According to a first aspect of the disclosure, a content sharing method is provided. The method includes: obtaining a first multimedia content to be shared in a terminal during a session between the terminal and a large model; performing a content desensitization processing on a sensitive content in the first multimedia content, and obtaining a second multimedia content by performing a type labeling processing on a position of the sensitive content in the first multimedia content, in which a type labeled by the type label processing is a type of the sensitive content; and sharing with the large model the second multimedia content for the session.

According to a second aspect of the disclosure, another content sharing method is provided. The method includes: obtaining a second multimedia content shared by a terminal during a session between the terminal and a large model, in which the second multimedia content is a content obtained by performing a content desensitization processing on a sensitive content in a first multimedia content of the terminal, and performing a type labeling processing on a position of the sensitive content in the first multimedia content; and replying to an input question of the terminal during the session according to the second multimedia content.

According to a third aspect of the disclosure, an electronic device is provided. The electronic device includes at least one processor and a memory communicatively connected to the at least one processor. The memory stores instructions executable by the at least one processor, and when the instructions are executed by the at least one processor, the at least one processor is caused to implement the content sharing methods described above in the disclosure.

It should be understood that the content described in this section is not intended to identify key or important features of the embodiments of the disclosure, nor is it intended to limit the scope of the disclosure. Additional features of the disclosure will be easily understood from the following description.

### BRIEF DESCRIPTION OF THE DRAWINGS

The accompanying drawings are used to better understand the solution and do not constitute a limitation to the disclosure, in which:

FIG. 1 is a schematic diagram according to a first embodiment of the disclosure.

FIG. 2 is a schematic diagram according to a second embodiment of the disclosure.

FIG. 3 is a schematic diagram according to a third embodiment of the disclosure.

FIG. 4 is a schematic diagram according to a fourth embodiment of the disclosure.

FIG. 5 is a schematic diagram according to a fifth embodiment of the disclosure.

FIG. 6 is a schematic diagram according to a sixth embodiment of the disclosure.

FIG. 7 is a block diagram of an electronic device for implementing a content sharing method of the embodiments of the disclosure.

### DETAILED DESCRIPTION

The following description of the example embodiments of the disclosure is provided in combination with the accompanying drawings, which includes various details of the embodiments of the disclosure to aid in understanding, and should be considered merely exemplary. Those skilled in the art understood that various changes and modifications of the embodiments described herein can be made without departing from the scope and spirit of the disclosure. For the sake of clarity and brevity, descriptions of well-known functions and structures are omitted from the following description.

Currently, in a session between a terminal and a large model, the terminal can share its screen content with the large model during the session.

In the existing solutions, the leakage of sensitive content may be caused while sharing the screen content.

In view of the above problems, the disclosure provides a content sharing method, a content sharing apparatus and an electronic device.

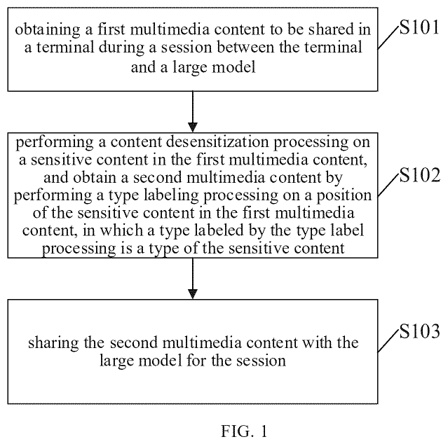

FIG. 1 is a schematic diagram according to a first embodiment of the disclosure. It should be noted that the content sharing method of the embodiments of the disclosure may be applied to the content sharing apparatus, and the apparatus is configured in the electronic device to enable a content sharing function.

The electronic device may be any device with a computing capability, such as a personal computer (PC), a mobile terminal, a terminal equipment, a server, etc. The mobile terminal may be, for example, a vehicle-mounted device, a mobile phone, a tablet computer, a personal digital assistant, a wearable device, a smart speaker, a server, a server cluster and other hardware devices with various operating systems, touch screens and/or displays.

The content sharing apparatus may also be software in the electronic device, e.g., content sharing software in the terminal or content sharing software in a server communicatively connected with the terminal. The following embodiments are described by taking the electronic device as the execution subject as an example.

As illustrated in FIG. 1, the content sharing method includes the following steps.

In step 101, a first multimedia content to be shared in a terminal is obtained during a session between the terminal and a large model.

In the embodiments of the disclosure, a sharing switch may be set in a session interface between the terminal and the large model. An object using the terminal (such as a user of the terminal) may switch on/off the sharing switch as needed. When the sharing switch is switched on, it indicates that a multimedia content in the terminal may be shared with the large model, and when the sharing switch is switched off, it indicates that the multimedia content in the terminal is prohibited to be shared with the large model.

When the terminal shares the content with the large model, the object using the terminal may select or set a multimedia content to be shared with the large model as needed. That is, the premise of sharing the multimedia content is detecting a selection operation or a setting operation performed by the object using the terminal. If no selection operation or setting operation is detected, it stops sharing the multimedia content with the large model.

In the embodiments of the disclosure, the first multimedia content may be any multimedia content to be shared by the terminal with the large model during the session.

The first multimedia content may be a multimedia content generated locally in the terminal, or a multimedia content in various software of the terminal. The first multimedia content may include at least one of: an image, a video, an audio, or a text, which is not specifically limited here and can be set according to actual needs.

The first multimedia content may be a content to be sent by the terminal to the large model, or a displayed content on a screen of the terminal.

In the embodiments of the disclosure, a sharing process between the terminal and the large model may be a continuous/discontinuous sharing process. For example, if the first multimedia content to be shared is the displayed content on the screen, the displayed content on the screen of the terminal may be shared with the large model continuously for a period of time. As another example, the sharing process starts when there is multimedia content to be shared, and the sharing process is ended once the sharing of the multimedia content is completed.

In step 102, a content desensitization processing is performed on a sensitive content in the first multimedia content, and a second multimedia content is obtained by performing a type labeling processing on a position of the sensitive content in the first multimedia content, in which a type labeled by the type label processing is a type of the sensitive content.

In the embodiments of the disclosure, the second multimedia content does not include the sensitive content, but includes the type of the sensitive content. For example, the second multimedia content may be a content obtained by replacing the sensitive content in the first multimedia content with the type of the sensitive content.

After sharing the second multimedia content with the large model, the large model cannot obtain the sensitive content, but can only obtain the type of the sensitive content, so as to prevent the large model from learning the sensitive content and outputting the sensitive content during the sessions with other terminals. By setting the type of the sensitive content, the session between the terminal and the large model will not be interrupted, which improves the fluency and efficiency of the session.

In the embodiments of the disclosure, the content desensitization processing includes at least one of: a pixelate processing, a blurring processing, or an overlaying processing.

For an image and/or a video in the first multimedia content, at least one of the pixelate processing, the blurring processing or the overlaying processing may be performed. For a text in the first multimedia content, the overlaying processing may be performed, for example, with masks or blanks. For an audio in the first multimedia content, the overlaying processing or the blurring processing may be performed, e.g., performing the overlaying processing with silence.

At least one way of performing content desensitization processing is set for the sensitive content, so that the sensitive content may be desensitized appropriately according to its media type, which improves the flexibility of the content desensitization processing.

In the embodiments of the disclosure, the sensitive content includes at least one of: object information, certificate information, financial information, voucher information, contact information or a terminal identifier (ID).

The object information may be information of the object using the terminal. The object information may be, for example, a name, a face image, a certificate image, etc. The certificate information may be, for example, an ID card number, a passport number, a driver's license number, a social security card number, an employee number, a student number, etc. The financial information may be, for example, a bank card number, a bank account number, etc. The voucher information may be, for example, a login account number, a plaintext password, a key code, etc.

The contact information may be, for example, a mobile phone number, a landline number, an email, an address, etc. The terminal ID may be, for example, an Internet protocol (IP) address, a media access control (MAC) address, etc.

The setting of various sensitive contents enables the object using the terminal to set the sensitive content according to actual needs, which improves the flexibility of setting the sensitive content and also improves the flexibility of the content desensitization processing.

In the embodiments of the disclosure, the type of the sensitive content may include at least one of: a media type of the sensitive content or a content type of the sensitive content.

The media type may be, for example, an image, a video, an audio, a text, etc. The content type may be, for example, a mobile phone number, an ID card number, a name, a face image, an address, etc., which can reflect the characteristic of the sensitive content. The content type may be set according to actual needs, which is not specifically limited here.

In the embodiments of the disclosure, the electronic device may determine the position of the sensitive content in the first multimedia content, and then adds the type of the sensitive content right at the position of the sensitive content or at a position near the position of the sensitive content, i.e., implements the type labeling processing on the position of the sensitive content.

For an image and/or a video in the first multimedia content, the position of the sensitive content may be a local area in the image. The type of the sensitive content may be added to the local area or an area near the local area (e.g., an area with no character included or a blank area).

For a text in the first multimedia content, the area where the sensitive content is located may be at least one character position in the text. The type of the sensitive content may be added to the at least one character position or a position near the at least one character position (e.g., a position with no character).

For an audio in the first multimedia content, the area where the sensitive content is located may be at least one audio frame position in the audio, i.e., a position of an audio frame on a time axis. The type of the sensitive content may be converted into a form of a plurality of audio frames and added to the at least one audio frame position.

By setting the media type and/or the content type, the large model can know part of information of the sensitive content, so that the large model can implement the session with the terminal based on non-sensitive contents and the part of information of the sensitive content, which prevent the session from being interrupted due to a lack of the sensitive content, which improves the fluency and efficiency of the session.

In the embodiments of the disclosure, in order to facilitate the electronic device to determine whether to perform the content desensitization processing on the first multimedia content according to the requirement of the object and to improve the flexibility of the content desensitization processing, before step 102, the electronic device may perform the following operations: obtaining a state of a switch for the content desensitization processing; and in a case where the state is an off state, determining the first multimedia content as the second multimedia content.

For example, the electronic device may display the switch on an interaction interface between the terminal and the large model, which is convenient for the object using the terminal to operate (such as, switch on/off) the switch as needed to change the state of the switch.

As another example, the electronic device may display the switch on a third setting interface, so that the user using the terminal may open the third setting interface and operate the switch on the third setting interface as needed to change the state of the switch.

In step 103, the second multimedia content is shared with the large model for the session.

In the embodiments of the disclosure, the large model may implement the session with the terminal in combination with the second multimedia content. For example, the large model may generate a reply in combination with the second multimedia content and send the reply to the terminal.

In the content sharing method of the embodiment of the disclosure, the first multimedia content to be shared in the terminal is obtained during the session between the terminal and the large model; the content desensitization processing is performed on the sensitive content in the first multimedia content, and the second multimedia content is obtained by performing the type labeling processing on the position of the sensitive content in the first multimedia content, in which the type labeled by the type label processing is the type of the sensitive content; the second multimedia content is shared with the large model for the session. Through the content desensitization processing and the type labeling processing on the sensitive content in the first multimedia content, it is possible to avoid sharing the sensitive content with the large model while sharing the multimedia content. Therefore, the large model will not learn the sensitive content and output the sensitive content during sessions with other terminals, which avoids the risk of leakage of the sensitive content and improves the security and efficiency of content sharing.

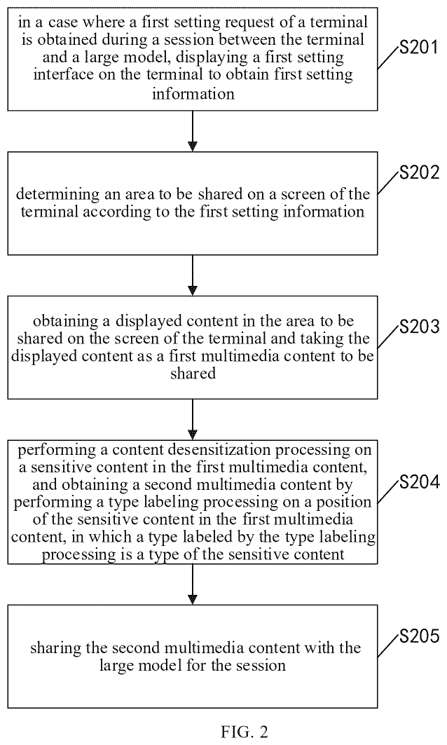

In order to further improve the security of content sharing and avoid sharing of the sensitive content, an area containing the sensitive content may be set as an unsharable area, and an area not containing the sensitive content may be set as an area to be shared. That is, the area to be shared on the screen of the terminal may be selected as required and then shared via the sharing processing. As illustrated in FIG. 2, FIG. 2 is a schematic diagram according to a second embodiment of the disclosure. The embodiment shown in FIG. 2 includes the following steps.

In step 201, in a case where a first setting request of a terminal is obtained during a session between the terminal and a large model, a first setting interface is displayed on the terminal to obtain first setting information.

In the embodiments of the disclosure, the third setting interface in the embodiment of FIG. 1 and the first setting interface here may be the same setting interface or different setting interfaces.

The first setting information may be setting information for an area on the screen of the terminal, for example, position information of the area to be shared, or position information of an area other than the area to be shared.

It should be noted that there may be one or more areas to be shared, which is not specifically limited here. After obtaining the first setting information, the first setting interface may be re-displayed as needed to modify the first setting information.

In step 202, an area to be shared on a screen of the terminal is determined according to the first setting information.

In the embodiments of the disclosure, for example, if the first setting information is the position information of the area to be shared, the area to be shared on the screen can be determined directly according to the first setting information. As another example, if the first setting information is the position information of the area other than the area to be shared, the unsharable area on the screen can be determined according to the first setting information, and an area on the screen other than the unsharable area can be determined as the area to be shared.

In step 203, a displayed content in the area to be shared on the screen of the terminal is obtained and taken as a first multimedia content to be shared.

In step 204, a content desensitization processing is performed on a sensitive content in the first multimedia content, and a second multimedia content is obtained by performing a type labeling processing on a position of the sensitive content in the first multimedia content, in which a type labeled by the type label processing is a type of the sensitive content.

In step 205, the second multimedia content is shared with the large model for the session.

In the embodiments of the disclosure, after step 205, the electronic device may perform the following processes: obtaining an input question of the terminal in the session; and feeding the input question to the large model, and instructing the large model to reply to the input question in combination with a second multimedia content related to the input question.

The second multimedia content related to the input question may include at least one of: a second multimedia content currently shared by the terminal; or a second multimedia content shared by the terminal at a previous time point.

The process for the electronic device to determine the second multimedia content related to the input question may include: determining whether the input question indicates the second multimedia content to be adopted, for example, through indicating a media type or a sharing time of the second multimedia content; in a case where the input question indicates the second multimedia content to be adopted, determining the second multimedia content as the second multimedia content related to the input question; in a case where the input question does not indicate the second multimedia content to be adopted, determining a matching degree between the input question and each second multimedia content, and selecting the second multimedia content related to the input question from respective second multimedia contents according to the matching degree.

The second multimedia content related to the input question may include at least one of a second multimedia content currently shared by the terminal or a second multimedia content shared by the terminal at a previous time point. By flexibly setting the second multimedia content related to the input question, the terminal can flexibly select the second multimedia content for the session between the terminal and the large model during the session. Therefore, the session between the terminal and the large model will not be interrupted, which improves the fluency and efficiency of the session.

In the embodiments of the disclosure, during the session between the terminal and the large model, the second multimedia content related to the input question may be displayed on a session interface, and stored in a session record. Correspondingly, when the sharing process is over, the large model may perform a session processing on the second multimedia content in the session record, e.g., implementing the reply processing, in combination with the second multimedia content in the session record and a new input question.

For example, in the case that the sharing process between the terminal and the large model is a continuous sharing process, the second multimedia content related to the input question may be stored in the session record in the continuous sharing process. For another example, in the case that the sharing process between the terminal and the large model is a discontinuous sharing process, the shared second multimedia content may be stored in the session record during the discontinuous sharing process.

It should be noted that regarding the details of steps 204-205, reference can be made to steps 102-103 in the embodiment shown in FIG. 1, which will not be described in detail here.

In the content sharing method of the embodiment of the disclosure, when the first setting request of the terminal is obtained during the session between the terminal and the large model, the first setting interface is displayed on the terminal to obtain the first setting information; the area to be shared on the screen of the terminal is determined according to the first setting information; the displayed content in the area to be shared on the screen of the terminal is obtained and taken as the first multimedia content to be shared; the content desensitization processing is performed on the sensitive content in the first multimedia content, and the second multimedia content is obtained by performing the type labeling processing on the position of the sensitive content in the first multimedia content, in which the type labeled by the type label processing is the type of the sensitive content; and the second multimedia content is shared with the large model for the session, in which the area containing the sensitive content is set as the unsharable area, and the area not containing the sensitive content is set as the area to be shared. That is, the area to be shared on the screen of the terminal can be selected as required, and then shared through the sharing processing, so as to improve the security of content sharing and avoid sharing of the sensitive content with the large model. Therefore, the large model will not learn the sensitive content and output the sensitive content during sessions with other terminals, and thus the risk of leakage of the sensitive content can be avoided.

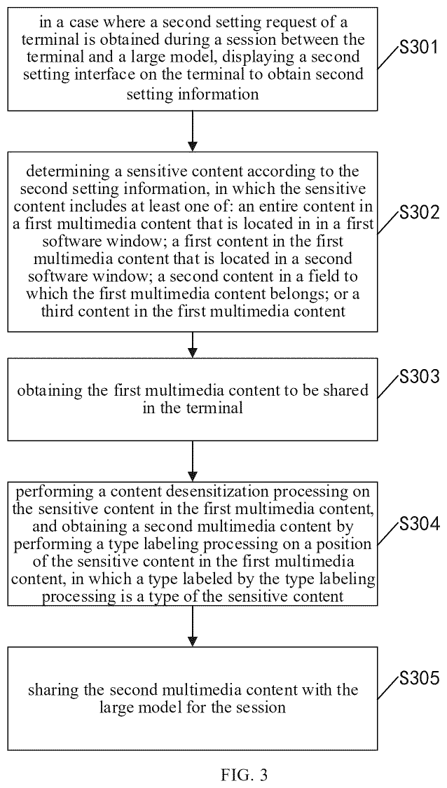

In order to further improve the flexibility of setting the sensitive content and further improve the security of content sharing, the sensitive content can be set for a software window and/or a field. As illustrated in FIG. 3, FIG. 3 is a schematic diagram according to a third embodiment of the disclosure. The embodiment shown in FIG. 3 includes the following steps.

In step 301, in a case where a second setting request of a terminal is obtained during a session between the terminal and a large model, a second setting interface is displayed on the terminal to obtain second setting information.

In the embodiments of the disclosure, the third setting interface in the embodiment of FIG. 1 and the second setting interface here may be the same setting interface or different setting interfaces.

The second setting information may be sensitive content setting information or non-sensitive content setting information. There may be one or more sensitive contents or non-sensitive contents PTDE12505764US set by the second setting information. After obtaining the second setting information, the second setting interface may be re-displayed as needed to modify the second setting information.

In step 302, a sensitive content is determined according to the second setting information.

The sensitive content includes at least one of: an entire content in a first multimedia content that is located in a first software window; a first content in the first multimedia content that is located in a second software window; a second content in a field to which the first multimedia content belongs; or a third content in the first multimedia content.

In step 303, a first multimedia content to be shared in the terminal is obtained.

In step 304, a content desensitization processing is performed on the sensitive content in the first multimedia content, and a second multimedia content is obtained by performing a type labeling processing on a position of the sensitive content in the first multimedia content, wherein a type labeled by the type labeling processing is a type of the sensitive content.

In the embodiments of the disclosure, in an example, if the sensitive content includes one of the sensitive contents mentioned in step 302, the electronic device may perform the content desensitization processing on the sensitive content in the first multimedia content according to this sensitive content.

As another example, if the sensitive content includes at least two of the sensitive contents mentioned in step 302, the electronic device determines priorities of the at least two sensitive contents, and performs the content desensitization processing on the at least two sensitive contents sequentially according to the priorities.

For example, if the sensitive content includes: the entire content in the first multimedia content that is located in the first software window and the first content in the first multimedia content that is located in the second software window, and the priority of the entire content in the first multimedia content that is located in the first software window is greater than the priority of the first content in the first multimedia content that is located in the second software window, the electronic device performs the content desensitization processing on the sensitive content in the first multimedia content according to the entire content in the first multimedia content that is located in the first software window, and then performs the content desensitization processing on the sensitive content in the first multimedia content again according to the first content in the first multimedia content that is located in the second software window.

When there are at least two sensitive contents, the content desensitization processing is performed on the sensitive content in the first multimedia content based on the at least two sensitive contents sequentially according to the respective priorities, which can reduce an amount of the first multimedia content to be processed during the content desensitization processing. For example, sensitive content recognition and processing may not be performed for some software windows, so as to further improve the efficiency of the content desensitization processing.

In the embodiments of the disclosure, in a case that the sensitive content includes the entire content in the first multimedia content that is located in a first software window, the process for the electronic device to perform the content desensitization processing on the sensitive content in the first multimedia content, includes: obtaining at least one software window and a content in the at least one software window by performing a software window recognition on the first multimedia content; and in a case where a software window is the first software window, performing the content desensitization processing on all the contents in the software window.

The first software window may be a window of a specific software, or a specific window of a specific software. The specific software may be, for example, an interaction software, a text processing software, etc. Taking the interaction software as an example, the specific window may be an interaction window or a window where an interaction object list is located. If the specific software is the text processing software, the specific window may be, for example, a text processing window.

The process for the electronic device to perform the software window recognition on the first multimedia content to obtain the at least one software window and the content in the at least one software window, includes: performing a window boundary recognition on the first multimedia content to determine the at least one software window; and performing a content recognition on an area where the at least one software window is located to determine the content in the at least one software window.

The electronic device may determine a software to which the software window belongs and which window of the software to which the software window belongs according to the content in the software window.

When the content desensitization processing is performed on the entire content in the first multimedia content that is located in the first software window, the content desensitization processing may be performed directly on the first software window under the condition that the entire content in the first software window is sensitive content, so as to avoid the leakage of the content in the first software window, which improves the flexibility of the content desensitization processing and improves the security of content sharing.

In the embodiments of the disclosure, in a case that the sensitive content includes the first content in the first multimedia content that is located in the second software window, the process for the electronic device to perform the content desensitization processing on the sensitive content in the first multimedia content, includes: obtaining at least one software window and a window content in the at least one software window by performing a software window recognition on the first multimedia content; and in a case where a software window is the second software window, for a window content in the software window, when the window content is the first content, performing the content desensitization processing on the window content.

The second software window may be a window of a specific software, or a specific window of a specific software. Different first contents, i.e., different sensitive contents, can be set for different software windows, and/or, different first contents i.e., different sensitive contents, can be set for different windows of the same software.

The content desensitization processing is performed on the first content in the first multimedia content that is located in the second software window. That is, the sensitive contents in different software windows are determined before performing the content desensitization processing, so as to avoid the leakage of the content in the second software window, which improves the flexibility of the content desensitization processing and improves the security of content sharing.

In the embodiments of the disclosure, in a case that the sensitive content includes the second content in the field to which the first multimedia content belongs, the process for the electronic device to perform the content desensitization processing on the sensitive content in the first multimedia content, includes: determining the field to which the first multimedia content belongs; obtaining at least one content to be processed by performing a content recognition on the first multimedia content; and in a case where the content to be processed is the second content in the field, performing the content desensitization processing on the content to be processed.

The first multimedia content may belong to one or more fields. In a case that the first multimedia content belongs to multiple fields, the electronic device may perform the content desensitization processing on the content to be processed if the content to be processed is the second content in any of the multiple fields.

Different second contents, i.e., different sensitive contents, may be set for different fields.

The content desensitization processing is performed on the second content in the field to which the first multimedia content belongs. Therefore, different sensitive contents are set for different fields, which improves the flexibility of the content desensitization processing and the security of content sharing.

In the embodiments of the disclosure, in a case that the sensitive content includes the third content in the first multimedia content, the process for the electronic device to perform the content desensitization processing on the sensitive content in the first multimedia content, includes: obtaining at least one content to be processed by performing a content recognition on the first multimedia content; and in a case where the content to be processed is the third content, performing the content desensitization processing on the content to be processed.

The third content in the example may be a common sensitive content in each first multimedia content. By performing the content desensitization processing on the common sensitive content in the first multimedia content, the omission of sensitive content can be avoided, thus improving the security of content sharing.

In the embodiments of the disclosure, in order to further improve the accuracy of content recognition, the process for the electronic device to perform the content recognition on the first multimedia content to obtain the at least one content to be processed, includes: determining a media type of the first multimedia content; and obtaining the at least one content to be processed by performing the recognition on the first multimedia content according to a recognition model corresponding to the media type.

The media type may be, for example, an images, a video, an audio, a text, etc. Different media types may correspond to different recognition models or the same recognition model. For example, different recognition models, e.g., an image recognition model and a video recognition model, are adopted for the image and the video. Or, the same recognition model, i.e., only the image recognition model, is adopted for the image and the video.

In step 305, the second multimedia content is shared with the large model for the session.

It should be noted that for the details of steps 303-305, reference can be made to steps 101-103 in the embodiment of FIG. 1, which will not be described in detail here.

In the content sharing method of the embodiment of the disclosure, when the second setting request of the terminal is obtained during the session between the terminal and the large model, the second setting interface is displayed on the terminal to obtain the second setting information; the sensitive content is determined according to the second setting information, in which the sensitive content includes at least one of: an entire content in a first multimedia content that is located in a first software window, a first content in the first multimedia content that is located in a second software window, a second content in a field to which the first multimedia content belongs, or a third content in the first multimedia content; the first multimedia content to be shared by the terminal is obtained; the content desensitization processing is performed on the sensitive content in the first multimedia content, and the second multimedia content is obtained by performing the type labeling processing on the position of the sensitive content in the first multimedia content, in which the type labeled by the type labeling processing is the type of the sensitive content; and the second multimedia content is shared with the large model for the session.

For the software window and/or the field, by setting the sensitive content and performing the content desensitization processing on the sensitive content, the flexibility of setting the sensitive content and the flexibility of the content desensitization processing are improved, thus further improving the security of content sharing.

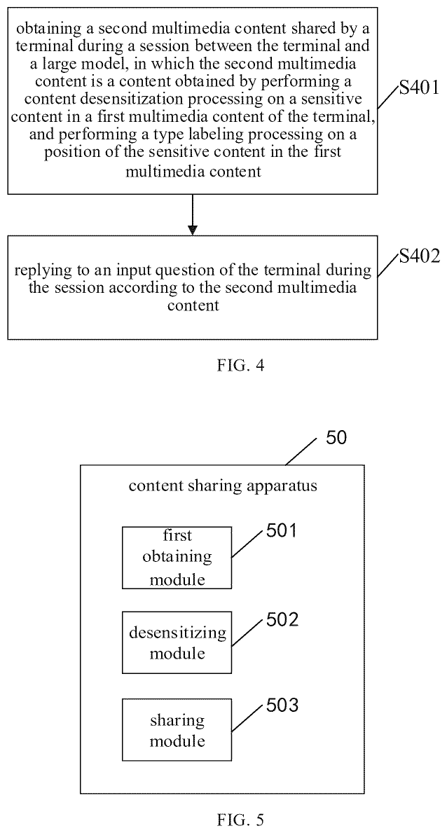

FIG. 4 is a schematic diagram according to a fourth embodiment of the disclosure. It should be noted that the content sharing method of the embodiment of the disclosure is applied to a content sharing apparatus, which is configured in an electronic device to enable a content sharing function.

The electronic device may be any device with a computing capability, such as a PC, a mobile terminal, a terminal, a server, etc. The mobile terminal may be, for example, a vehicle-mounted device, a mobile phone, a tablet computer, a personal digital assistant, a wearable device, a smart speaker, a server, a server cluster and other hardware devices with various operating systems, touch screens and/or displays.

The content sharing apparatus may be software in the electronic device, such as content sharing software in a server. The following embodiments are described by taking the electronic PTDE12505764US device as the execution subject as an example.

As illustrated in FIG. 4, the content sharing method includes the following steps.

In step 401, a second multimedia content shared by a terminal is obtained during a session between the terminal and a large model, in which the second multimedia content is a content obtained by performing a content desensitization processing on a sensitive content in a first multimedia content of the terminal, and performing a type labeling processing on a position of the sensitive content in the first multimedia content.

In the embodiments of the disclosure, the first multimedia content may be any multimedia content shared by the terminal with the large model during the session.

The first multimedia content may be a multimedia content generated locally in the terminal, or a multimedia content in various software of the terminal. The first multimedia content may include at least one of: an image, a video, an audio, or a text, which is not specifically limited here and can be set according to actual needs.

In the embodiments of the disclosure, the content desensitization processing may include at least one of: a pixelate processing, a blurring processing, or an overlaying processing.

In the embodiments of the disclosure, the sensitive content may include at least one of: object information, certificate information, financial information, voucher information, contact information or a terminal ID.

In the embodiments of the disclosure, the type of the sensitive content may include at least one of: a media type of the sensitive content or a content type of the sensitive content.

In step 402, a reply processing is performed to an input question of the terminal during the session according to the second multimedia content.

In the embodiments of the disclosure, the process for the electronic device to execute step 402 includes: obtaining the input question of the terminal during the session; and replying to the input question according to a second multimedia content related to the input question.

The second multimedia content related to the input problem may include at least one of: a second multimedia content currently shared by the terminal, or a second multimedia content shared by the terminal at a previous time point.

In the content sharing method of the embodiment of the disclosure, the second multimedia content shared by the terminal is obtained during the session between the terminal and the large model, in which the second multimedia content is the content obtained by performing the content desensitization processing on the sensitive content in the first multimedia content of the terminal, and performing the type labeling processing on the position of the sensitive content in the first multimedia content; the reply to the input question of the terminal during the session is provided according to the second multimedia content. The second multimedia content does not include the sensitive content, but includes the type of the sensitive content, so that the risk of leakage of the sensitive content can be avoided while sharing the multimedia content, which improves the security and efficiency of content sharing.

In order to implement the above embodiments, the disclosure also provides a content sharing apparatus. As illustrated in FIG. 5, FIG. 5 is a schematic diagram according to a fifth embodiment of the disclosure. The content sharing apparatus 50 may include: a first obtaining module 501, a desensitizing module 502 and a sharing module 503.

The first obtaining module 501 is configured to obtain a first multimedia content to be shared in a terminal during a session between the terminal and a large model. The desensitizing module 502 is configured to perform a content desensitization processing on a sensitive content in the first multimedia content, and obtain a second multimedia content by performing a type labeling processing on a position of the sensitive content in the first multimedia content, in which a type labeled by the type label processing is a type of the sensitive content. The sharing module 503 is configured to share with the large model the second multimedia content for the session.

In a possible implementation of the embodiments of the disclosure, the first multimedia content includes a displayed content in an area to be shared on a screen of the terminal, and the area to be shared includes any of: an entire area on the screen, or at least one local area on the screen.

In a possible implementation of the embodiments of the disclosure, the apparatus further includes: a first displaying module and a first determining module. The first displaying module is configured to, in a case where a first setting request of the terminal is obtained, display a first setting interface on the terminal to obtain first setting information. The first determining module is configured to determine the area to be shared on the screen of the terminal according to the first setting information.

In a possible implementation of the embodiments of the disclosure, the sensitive content includes at least one of: an entire in the first multimedia content that is located in a first software window; a first content in the first multimedia content that is located in a second software window; a second content in a field to which the first multimedia content belongs; or a third content in the first multimedia content.

In a possible implementation of the embodiments of the disclosure, the apparatus further includes: a second displaying module and a second determining module. The second displaying module is configured to, in a case where a second setting request of the terminal is obtained, display a second setting interface on the terminal to obtain second setting information. The second determining module is configured to determine the sensitive content according to the second setting information.

In a possible implementation of the embodiments of the disclosure, the desensitizing module 502 is further configured to: in a case where there are at least two sensitive contents in the first multimedia content, determine priorities of the at least two sensitive contents, respectively; and perform the content desensitization processing on the at least two sensitive contents sequentially according to the priorities.

In a possible implementation of the embodiments of the disclosure, the sensitive content includes an entire content in the first multimedia content that is located in a first software window, the desensitizing module 502 is further configured to: obtain at least one software window and contents in the at least one software window by performing a software window recognition on the first multimedia content; and in a case where a software window is the first software window, perform the content desensitization processing on all the contents in the software window.

In a possible implementation of the embodiments of the disclosure, the sensitive content includes a first content in the first multimedia content that is located in a second software window, the desensitizing module 502 is further configured to: obtain at least one software window and a window content in the at least one software window by performing a software window recognition on the first multimedia content; and in a case where a software window is the second software window, for a window content in the software window, when the window content is the first content, perform the content desensitization processing on the window content.

In a possible implementation of the embodiments of the disclosure, the sensitive content includes a second content in a field to which the first multimedia content belongs, the desensitizing module 502 is further configured to: determine the field to which the first multimedia content belongs; obtain at least one content to be processed by performing a content recognition on the first multimedia content; and in a case where a content to be processed is the second content in the field, perform the content desensitization processing on the content to be processed.

In a possible implementation of the embodiments of the disclosure, the sensitive content includes a third content in the first multimedia content, the desensitizing module 502 is further configured to: obtain at least one content to be processed by performing a content recognition on the first multimedia content; and in a case where a content to be processed is the third content, perform the content desensitization processing on the content to be processed.

In a possible implementation of the embodiments of the disclosure, the desensitizing module 502 is further configured to: determine a media type of the first multimedia content; and obtain the at least one content to be processed by performing the content recognition on the first multimedia content according to a recognition model corresponding to the media type.

In a possible implementation of the embodiments of the disclosure, the content desensitization processing includes at least one of: a pixelate processing, a blurring processing, or an overlaying processing.

In a possible implementation of the embodiments of the disclosure, the type of the sensitive content includes at least one of: a media type of the sensitive content; or a content type of the sensitive content.

In a possible implementation of the embodiments of the disclosure, the apparatus further includes: a second obtaining module and a third determining module. The second obtaining module is configured to obtain a state of a switch for the content desensitization processing. The third determining module is configured to, in a case where the state is an off state, determine the first multimedia content as the second multimedia content.

In a possible implementation of the embodiments of the disclosure, the apparatus further includes: a third obtaining module and a sending module. The third obtaining module is configured to obtain an input question of the terminal in the session. The sending module is configured to feed the input question to the large model, and instruct the large model to reply to the input question in combination with a second multimedia content related to the input question.

In a possible implementation of the embodiments of the disclosure, the second multimedia content related to the input question includes at least one of: a second multimedia content currently shared by the terminal; or a second multimedia content shared by the terminal at a previous time point.

In a possible implementation of the embodiments of the disclosure, the sensitive content includes at least one of: object information, certificate information, financial information, voucher information, contact information or a terminal ID.

With the content sharing apparatus of the embodiment of the disclosure, the first multimedia content to be shared in the terminal is obtained during the session between the terminal and the large model; the content desensitization processing is performed on the sensitive content in the first multimedia content, and the second multimedia content is obtained by performing the type labeling processing on the position of the sensitive content in the first multimedia content, in which the type labeled by the type labeling processing is the type of the sensitive content; and the second multimedia content is shared with the large model for the session. Through the content desensitization processing and the type labeling processing on the sensitive content in the first multimedia content, it is possible to avoid sharing of the sensitive content with the large model while sharing the multimedia content, so that the large model cannot learn the sensitive content and output the sensitive content during sessions with other terminals. Therefore, the risk of leakage of the sensitive content can be avoided, and the security and efficiency of content sharing are improved.

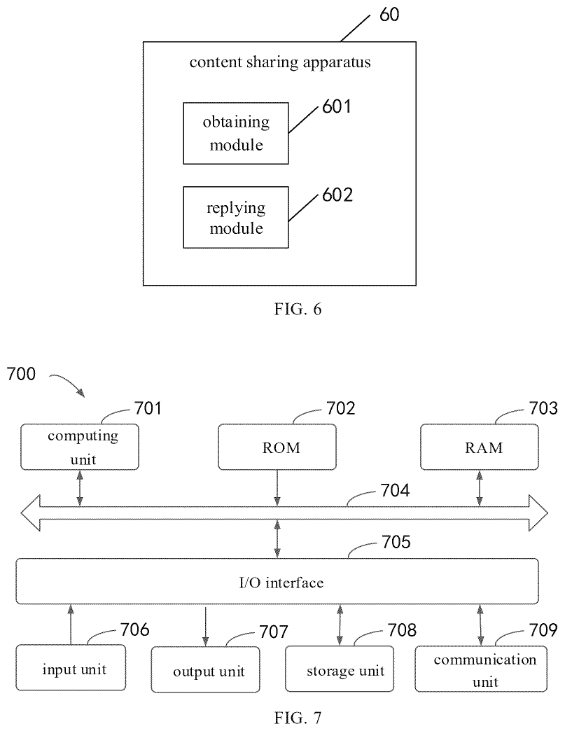

In order to implement the above embodiments, the disclosure also provides a content sharing apparatus. As illustrated in FIG. 6, FIG. 6 is a schematic diagram according to a sixth embodiment of the disclosure. The content sharing apparatus 60 includes an obtaining module 601 and a replying module 602.

The obtaining module 601 is configured to obtain a second multimedia content shared by a terminal during a session between the terminal and a large model, in which the second multimedia content is a content obtained by performing a content desensitization processing on a sensitive content in a first multimedia content of the terminal, and performing a type labeling processing on a position of the sensitive content in the first multimedia content. The replying module 602 is configured to reply to an input question of the terminal during the session according to the second multimedia content.

With the content sharing apparatus of the embodiment of the disclosure, the second multimedia content shared by the terminal is obtained during the session between the terminal and the large model, in which the second multimedia content is the content obtained by performing PTDE12505764US the content desensitization processing on the sensitive content in the first multimedia content of the terminal, and performing the type labeling processing on the position of the sensitive content in the first multimedia content; and the reply to the input question of the terminal during the session is provided according to the second multimedia content. The second multimedia content does not include the sensitive content, but includes the type of the sensitive content, so that the risk of leakage of the sensitive content can be avoided while sharing the multimedia content, which improves the security and efficiency of content sharing.

In the technical solution of the disclosure, collection, storage, usage, processing, transmission, provision and disclosure of personal information of the user are all carried out with the consent of the user, and all comply with the provisions of relevant laws and regulations, and do not violate public order and good customs.

According to the embodiments of the disclosure, the disclosure also provides an electronic device, a readable storage medium and a computer program product.

FIG. 7 is a schematic block diagram of an example electronic device 700 that can be used to implement the embodiments of the disclosure. The electronic device is intended to represent various forms of digital computers, such as a laptop computer, a desktop computer, a workbench, a personal digital assistant, a server, a blade server, a mainframe computer and other suitable computers. The electronic device may also represent various forms of mobile devices, such as a personal digital processor, a cellular phone, a smart phone, a wearable device and other similar computing devices. The components shown here, their connections and relations, and their functions are merely exemplary, and are not intended to limit the implementations of the disclosure described and/or required herein.

As illustrated in FIG. 7, the device 700 includes: a computing unit 701 for performing various appropriate actions and processes according to computer programs stored in a read-only memory (ROM) 702 or computer programs loaded from a storage unit 708 to a random access memory (RAM) 703. The RAM 703 may also stores necessary programs and data for the device 700 to operate. The computing unit 701, the ROM 702 and the RAM 703 are connected to each other through a bus 704. An input/output (I/O) interface 705 is also connected to the bus 704.

Components in the device 700 are connected to the I/O interface 705, including: an input unit 706, such as a keyboard and a mouse; an output unit 707, such as various types of displays and speakers; the storage unit 708, such as a disk and an optical disk; and a communication unit 709, such as a network card, a modem and a wireless communication transceiver. The communication unit 709 allows the device 700 to exchange information/data with other devices through a computer network such as the Internet and/or various telecommunication networks.

The computing unit 701 may be various general-purpose and/or dedicated processing components having processing and computing capabilities. Some examples of the computing unit 701 include, but are not limited to, a central processing unit (CPU), a graphics processing unit (GPU), various dedicated artificial intelligence computing chips, various computing units that run machine learning model algorithms, a digital signal processor (DSP) and any appropriate processor, controller or microcontroller. The computing unit 701 executes the various methods and processes described above, such as the content sharing method. For example, in some embodiments, the above method may be implemented as a computer software program, which is tangibly contained in a machine readable medium, such as the storage unit 708. In some embodiments, part or all of the computer programs may be loaded and/or installed on the device 700 via the ROM 702 and/or the communication unit 709. When the computer program is loaded on the RAM 703 and executed by the computing unit 701, one or more steps of the above method may be executed. Alternatively, in other embodiments, the computing unit 701 may be configured to perform the above method in any other suitable manner (for example, by means of firmware).

Various implementations of the systems and techniques described above may be implemented by a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware/firmware/software, and/or any combination thereof. These implementations may be implemented in one or more computer programs, the one or more computer programs may be executed and/or interpreted on a programmable system including at least one programmable processor, which may be a dedicated or general programmable processor for receiving data and instructions from a storage system, at least one input device and at least one output device, and transmitting data and instructions to the storage system, the at least one input device and the at least one output device.

The program code configured to implement the method of the disclosure may be written in any combination of one or more programming languages. These program codes may be provided to a processor/controller of a general-purpose computer, a dedicated computer or other programmable data processing devices, so that when the program code is executed by the processor/controller, the functions/operations specified in the flowchart and/or block diagram can be implemented. The program code may be executed entirely on a machine, partly executed on the machine, partly executed on the machine and partly executed on a remote machine as an independent software package, or entirely executed on the remote machine or the server.

In the context of the disclosure, a machine-readable medium may be a tangible medium that may contain or store a program for use by or in combination with an instruction execution system, an apparatus, or a device. The machine-readable medium may be a machine-readable signal medium or a machine-readable storage medium. The machine-readable medium includes, but is not limited to, an electronic, magnetic, optical, electromagnetic, infrared, or semiconductor system/apparatus/device, or any suitable combination of the above. More specific examples of the machine-readable storage medium include electrical connections based on one or more wires, portable computer disks, hard disks, RAMs, ROMs, electrically programmable read-only-memories (EPROMs) or flash memories, fiber optics, compact disc ROMs (CD-ROMs), optical storage devices, magnetic storage devices, or any suitable combination of the foregoing.

In order to provide interaction with a user, the systems and techniques described herein may be implemented on a computer having a display device (e.g., a cathode ray tube (CRT) or a liquid crystal display (LCD) monitor) for displaying information to a user; and a keyboard and a pointing device (such as a mouse or trackball) through which the user can provide input to the computer. Other kinds of devices may also be used to provide interaction with the user. For example, the feedback provided to the user may be any form of sensory feedback (e.g., visual feedback, auditory feedback or haptic feedback), and the input from the user may be received in any form (including acoustic input, voice input or tactile input).

The systems and technologies described herein can be implemented in a computing system that includes back-end components (for example, a data server), or a computing system that includes middleware components (for example, an application server), or a computing system that includes front-end components (for example, a user computer with a graphical user interface or a web browser, through which the user can interact with the implementations of the systems and technologies described herein), or a computing system that includes any combination of such back-end components, middleware components and front-end components. The components of the system may be interconnected by any form or medium of digital data communication (e.g., a communication network). The communication network may include, for example, a local area network (LAN), a wide area network (WAN), and the Internet.

The computer system may include a client and a server. The client and the server are generally remote from each other and interacting through a communication network. The client-server relation is generated by computer programs running on the respective computers and having a client-server relation with each other. The server may be a cloud server, a server with a distributed system, or a server combined with a block-chain.

It is understandable that the steps can be reordered, added or deleted using various forms of the processes shown above. For example, the steps in the disclosure may be performed in parallel, sequentially or in different orders, as long as the desired result of the technical solution disclosed in the disclosure is achieved, which is not limited herein.

The specific implementations described above do not constitute a limitation on the scope of protection of the disclosure. It should be understood by those skilled in the art that various modifications, combinations, sub-combinations and substitutions can be made depending on the design requirements and other factors. Any modifications, equivalent substitutions and improvements made within the spirit and principles of the disclosure shall be included in the scope of protection of the disclosure.

1. A content sharing method, comprising:
obtaining a first multimedia content to be shared in a terminal during a session between the terminal and a large model;
performing a content desensitization processing on a sensitive content in the first multimedia content, and obtaining a second multimedia content by performing a type labeling processing on a position of the sensitive content in the first multimedia content, wherein a type labeled by the type label processing is a type of the sensitive content; and
sharing with the large model the second multimedia content for the session.

2. The method of claim 1, wherein the first multimedia content comprises a displayed content in an area to be shared on a screen of the terminal; and
the area to be shared comprises any of:
an entire area on the screen; or
at least one local area on the screen.

3. The method of claim 2, further comprising:
in a case where a first setting request of the terminal is obtained, displaying a first setting interface on the terminal to obtain first setting information; and
determining the area to be shared on the screen of the terminal according to the first setting information.

4. The method of claim 1, wherein the sensitive content comprises at least one of:
an entire in the first multimedia content that is located in a first software window;
a first content in the first multimedia content that is located in a second software window;
a second content in a field to which the first multimedia content belongs; or
a third content in the first multimedia content.

5. The method of claim 4, further comprising:
in a case where a second setting request of the terminal is obtained, displaying a second setting interface on the terminal to obtain second setting information; and
determining the sensitive content according to the second setting information.

6. The method of claim 4, wherein performing the content desensitization processing on the sensitive content in the first multimedia content, comprises:
in a case where there are at least two sensitive contents in the first multimedia content, determining priorities of the at least two sensitive contents, respectively; and
performing the content desensitization processing on the at least two sensitive contents sequentially according to the priorities.

7. The method of claim 1, wherein the sensitive content comprises an entire in the first multimedia content that is located in a first software window, and performing the content desensitization processing on the sensitive content in the first multimedia content, comprises:
obtaining at least one software window and a content in the at least one software window by performing a software window recognition on the first multimedia content; and
in a case where a software window is the first software window, performing the content desensitization processing on all contents in the software window.

8. The method of claim 1, wherein the sensitive content comprises a first content in the first multimedia content that is located in a second software window, and performing the content desensitization processing on the sensitive content in the first multimedia content, comprises:
obtaining at least one software window and a window content in the at least one software window by performing a software window recognition on the first multimedia content; and
in a case where a software window is the second software window, for a window content that is the first content in the software window, performing the content desensitization processing on the window content.

9. The method of claim 1, wherein the sensitive content comprises a second content in a field to which the first multimedia content belongs, and performing the content desensitization processing on the sensitive content in the first multimedia content, comprises:
determining the field to which the first multimedia content belongs;
obtaining at least one content to be processed by performing a content recognition on the first multimedia content; and
in a case where a content to be processed is the second content in the field, performing the content desensitization processing on the content to be processed.

10. The method of claim 1, wherein the sensitive content comprises a third content in the first multimedia content, and performing the content desensitization processing on the sensitive content in the first multimedia content, comprises:
obtaining at least one content to be processed by performing a content recognition on the first multimedia content; and
in a case where a content to be processed is the third content, performing the content desensitization processing on the content to be processed.

11. The method of claim 9, wherein obtaining the at least one content to be processed by performing the content recognition on the first multimedia content, comprises:
determining a media type of the first multimedia content; and
obtaining the at least one content to be processed by performing the content recognition on the first multimedia content according to a recognition model corresponding to the media type.

12. The method of claim 1, wherein the content desensitization processing comprises at least one of:
a pixelate processing, a blurring processing, or an overlaying processing.

13. The method of claim 1, wherein the type of the sensitive content comprises at least one of:
a media type of the sensitive content; or
a content type of the sensitive content.

14. The method of claim 1, wherein before performing the content desensitization processing on the sensitive content in the first multimedia content, and obtaining the second multimedia content by performing the type labeling processing on the position of the sensitive content in the first multimedia content, the method further comprises:
obtaining a state of a switch for the content desensitization processing; and
in a case where the state is an off state, determining the first multimedia content as the second multimedia content.

15. The method of claim 1, further comprising:
obtaining an input question of the terminal in the session; and
feeding the input question to the large model, and instructing the large model to reply to the input question in combination with a second multimedia content related to the input question.

16. The method of claim 15, wherein the second multimedia content related to the input question comprises at least one of:
a second multimedia content currently shared by the terminal; or
a second multimedia content shared by the terminal at a previous time point.

17. The method of claim 1, wherein the sensitive content comprises at least one of:
object information, certificate information, financial information, voucher information, contact information or a terminal identifier.

18. A content sharing method, comprising:
obtaining a second multimedia content shared by a terminal during a session between the terminal and a large model, wherein the second multimedia content is a content obtained by performing a content desensitization processing on a sensitive content in a first multimedia content of the terminal, and performing a type labeling processing on a position of the sensitive content in the first multimedia content; and
replying to an input question of the terminal during the session according to the second multimedia content.

19. An electronic device, comprising:
at least one processor; and
a memory communicatively connected to the at least one processor;
wherein the memory stores instructions executable by the at least one processor, and when the instructions are executed by the at least one processor, the at least one processor is caused to implement:
obtaining a first multimedia content to be shared in a terminal during a session between the terminal and a large model;
performing a content desensitization processing on a sensitive content in the first multimedia content, and obtaining a second multimedia content by performing a type labeling processing on a position of the sensitive content in the first multimedia content, wherein a type labeled by the type label processing is a type of the sensitive content; and
sharing with the large model the second multimedia content for the session.

20. An electronic device, comprising:
at least one processor; and
a memory communicatively connected to the at least one processor;
wherein the memory stores instructions executable by the at least one processor, and when the instructions are executed by the at least one processor, the at least one processor is caused to implement the method of claim 18.
